(19) United States
(12) Patent Application Publication
(10) Pub. No.: US 2026/0001310 A1
(43) Pub. Date: Jan. 1, 2026

(54) Fixing Device for a Decorative Layer to Be Laminated on a Carrier Structure

(71) Applicant: Bayerische Motoren Werke Aktiengesellschaft, Muenchen (DE)

(72) Inventors: Florian DECHANT, Adlkofen (DE); Christian WEGER, Hohenthann (DE)

(21) Appl. No.: 19/246,892

(22) Filed: Jun. 24, 2025

(30) Foreign Application Priority Data
Jun. 26, 2024 (DE) 10 2024 118 014.5

(51) Int. Cl. B32B 43/00; B32B 37/00; B32B 39/00; B32B 41/00

(52) U.S. Cl. CPC B32B 43/003; B32B 37/0046; B32B 39/00; B32B 41/00

(57) ABSTRACT

A fixing device for a decorative layer to be laminated on a carrier structure comprising a seam blade and a support, on which the carrier structure and the decorative layer are arrangeable such that the decorative layer covers the carrier structure at least in some sections. The seam blade comprises a seam blade edge and is designed to fix the decorative layer and the carrier structure on one another using the seam blade edge along a predetermined seam contour on the support. The fixing device furthermore comprises an illumination unit which is designed to illuminate the support along the seam contour.

### CROSS REFERENCE TO RELATED APPLICATION

This application claims priority under 35 U.S.C. § 119 from German Patent Application No. 10 2024 118 014.5, filed Jun. 26, 2024, the entire disclosure of which is herein expressly incorporated by reference.

### BACKGROUND AND SUMMARY

This disclosure relates to a fixing device for a decorative layer to be laminated on a carrier structure.

Laminating devices and fixing devices for fixing a decorative layer to be laminated on a carrier structure on the carrier structure have been known for some time. The use of seam blades to press the decorative layer along a seam contour against the carrier structure or also against a counter bearing, which can be designated as a support, and thus fix the decorative layer for the actual laminating process subsequently taking place in a predetermined position on the carrier structure, is also known.

It is often necessary in this case to align the decorative layer manually on the carrier structure or carrier structure and decorative layer on the support and also carrier structure and/or decorative layer relative to the seam blade, so that an edge or predetermined area of the decorative layer extends exactly along the seam contour defined by the seam blade edge.

However, it is problematic in this case that the seam blade itself or other structures of the laminating and/or fixing device create a shadow on the support, the decorative layer, and/or the carrier structure, which makes the accurate positioning of the decorative layer significantly more difficult. This is true in particular if dark materials are used as the decorative layer, since the accurate course of the dark decorative layer is no longer recognizable or is at least no longer easily recognizable in the area of the shadow for the operator carrying out the manual alignment.

The disclosure is therefore based on an object of overcoming the above-mentioned disadvantages and providing a fixing device for a decorative layer to be laminated on a carrier structure, using which the decorative layer and preferably also the carrier structure are alignable more easily with respect to a predetermined seam contour.

According to the disclosure, a fixing device for a decorative layer to be laminated on a carrier structure is therefore proposed, wherein the fixing device comprises a support and a seam blade. The carrier structure and the decorative layer are arrangeable on the support, which can also be referred to as a support body, cushion, or counter bearing, such that the decorative layer covers the carrier structure at least in some sections. To clarify, the support is thus preferably designed to support the carrier structure flatly, so that the decorative layer is arrangeable on the carrier structure flatly covering the carrier structure and carrier structure and decorative layer can subsequently be laminated with one another, i.e. are flatly connectable to one another in a laminating process. It is furthermore provided according to the disclosure that the seam blade in particular comprises a seam blade edge facing toward the support and is designed to fix the decorative layer and the carrier structure on one another using the seam blade edge along a predetermined seam contour, preferably in a formfitting and/or friction-locked manner on the support, wherein the seam contour is accordingly defined in particular by the seam blade edge or the course of the seam blade edge. It is advantageous here that the fixing device furthermore comprises an illumination unit (for example, one or more lights), which can possibly also be designated as the first illumination unit and is designed to illuminate the support or the decorative layer arranged together with the carrier structure on the support along the seam contour or along an imaginary course of the seam contour on the support or on the decorative layer, by which the shadow is thus eliminated or at least reduced and the manual alignment is greatly simplified for the operator. The illumination unit is preferably designed here to illuminate an area on the support directly adjoining the seam contour.

In the case of a plurality of fixing devices, a seam blade bridge is provided, on which the seam blade is held directly or indirectly via actuators for moving the seam blade. In a refinement providing such a seam blade bridge, it is preferably provided that the seam blade is movable together with the seam blade bridge and/or starting from the seam blade bridge for fixing the decorative layer and the carrier structure against the support, wherein the illumination unit is arranged on the seam blade bridge.

It is relevant here that the shadow is often generated by the seam blade bridge, since illumination means (for example, one or more lights) for illuminating the working area at the fixing device are often arranged above the seam blade bridge. Therefore, on the one hand, a shadow due to the seam blade bridge is eliminated and, on the other hand, a component present in any case is used as a carrier for structural integration of the illumination unit in the fixing device.

Furthermore, it is preferably provided in this case that the seam blade bridge spans the support spaced apart therefrom, wherein the illumination unit is provided on a side of the seam blade bridge facing toward the support.

Although the (first) illumination unit is preferably arranged on the seam blade bridge, an additional advantageous effect can be achieved by skilled positioning. If the first illumination unit or a third illumination unit also mentioned hereinafter is positioned, for example, on the support and such that the generated light is emitted parallel to a surface of the decorative layer facing toward the seam blade, a clearly perceptible shadow will be generated by any projections of the decorative layer along the seam contour, so that they are more easily perceptible to the operator. If two illumination units, i.e., for example, the first and the third illumination unit, are used for the illumination of the area adjoining the seam contour and for the illumination parallel to the surface, they can each use different colors, so that these colors mix outside the shadow of the projection and the projection is also better recognizable due to the colors resulting on the surface of the decorative layer.

Since the seam contour extends linearly, it is preferably provided that the illumination unit is formed from a plurality of illumination means preferably arranged in a row. Alternatively, it can accordingly be provided that the illumination unit is designed as a band, thus, for example, as an LED light band, and extends corresponding to the seam contour, so that the seam contour can be illuminated over its course or the imaginary course corresponding to the seam contour over its entire length.

In principle, the fixing device can furthermore comprise a mechanical alignment aid for aligning the decorative layer and/or the carrier structure on the support, wherein in a simple case this can be a mechanical stop. One refinement of the present disclosure provides here that the illumination unit is designed to illuminate an area adjoining the mechanical alignment aid on the support or an area of the carrier structure and/or the decorative layer adjoining the mechanical alignment aid, so that the shadow is also reduced or eliminated here and the manual alignment is simplified. Additionally or alternatively, a further or second illumination unit can also be provided for this purpose, which is accordingly designed to illuminate the area on the support adjoining the mechanical alignment aid or an area of the carrier structure and/or the decorative layer adjoining the mechanical alignment aid.

As mentioned, the fixing device can furthermore comprise a working area, at which the decorative layer and/or the carrier structure are manually alignable by an operator on the support. In this case, a longitudinal side of the seam blade faces toward the working area, wherein the illumination unit is positioned and/or formed between the working area and the weld seam to illuminate the longitudinal side of the weld seam, so that the reduction or elimination of the shadow thus takes place on a side of the seam blade facing toward the operator.

However, to enable a check on a side of the seam blade facing away from the working area, it can also be provided that a further illumination unit or a second part of the first illumination unit is designed to illuminate the area adjoining the seam blade edge on the support on a side of the seam blade facing away from the working area.

Moreover, the illumination unit can be designed and/or the fixing device can comprise a further or third illumination unit, which is designed to generate or project an optical alignment aid on the support or at/on the carrier structure and/or decorative layer arranged on the support. For example, a course offset in parallel to the course of the seam blade or a predetermined course of an edge of the decorative layer and/or the carrier structure can thus be projected. For example, the third illumination unit can be designed as a line laser for this purpose or can use a prism or also other optical devices, by which clearly bounded contours are projectable on the support/the carrier structure/the decorative layer.

A variant is particularly advantageous in which the fixing device furthermore comprises a control unit connected for signaling to the illumination unit and/or to the second illumination unit and/or third illumination unit, which control unit is designed to visually display at least one status report of the fixing device by actuating the illumination unit. In addition to status reports displaying operating states, operating pressures, and/or other machine parameters of the fixing device, it is additionally or alternatively possible that the fixing device comprises sensors which, for example, detect the positioning of the carrier structure and/or the decorative layer on the support and/or on one of the mechanical or optical alignment aids. If it is detected by such a sensor that the carrier structure and/or the decorative layer is in a predetermined position, this can be displayed by way of the control unit as a status report by the illumination unit. Not only one other display device is replaced by the use of the illumination unit to display a status report. It is decisive that the operator who is concentrating on the alignment of the decorative layer and the carrier structure does not have to look away to register the status report, since this is displayed directly in the working area defined by the manual alignment. The work is significantly simplified here by status reports which assist the manual alignment and the work safety is significantly enhanced by safety-relevant status reports.

For example, the status reports can be output by a change of the light color or a change of the light current, i.e. a changing light brightness. It can therefore be provided that the illumination unit is designed to change a light color and/or a light current of a light generated for the illumination.

Although it is generally true that the (first) illumination unit, but also the second and/or third illumination unit, are formed by a plurality of in particular multicolored light sources, it can be provided, for example, that these are formed by a plurality of multicolor LEDs or RGB-LEDs or RGBW-LEDs, which are accordingly actuatable jointly or in groups.

Furthermore, it is preferably provided that a direct line of sight between the (first) illumination unit and the support is free of obstacles generating a shadow on the support. To clarify, neither the carrier structure nor the decorative layer form such obstacles, so that alternatively it is also true that a direct line of sight between the (first) illumination unit and the decorative layer is free of obstacles generating a shadow on the decorative layer.

To clarify, it should moreover be noted that the seam blade can be in one piece and can comprise a one-piece seam blade edge, which is designed to fix the decorative layer and the carrier structure over an entire length of the seam contour on the support. Alternatively, however, it can also be provided that the seam blade is in multiple parts and the parts of the seam blade jointly form the seam blade edge, which is designed to fix the decorative layer and the carrier structure over an entire length of the seam contour on the support.

The features disclosed above can be combined as desired, insofar as this is technically possible and they are not mutually exclusive.

Other advantageous developments of the disclosure are illustrated in more detail below together with the description of the preferred embodiment of the disclosure on the basis of the figures. In the figures:

### BRIEF DESCRIPTION OF THE DRAWINGS

FIG. 1 shows a side view of a fixing device; and,

FIG. 2 shows a top view of a support of a fixing device.

### DETAILED DESCRIPTION OF THE DRAWINGS

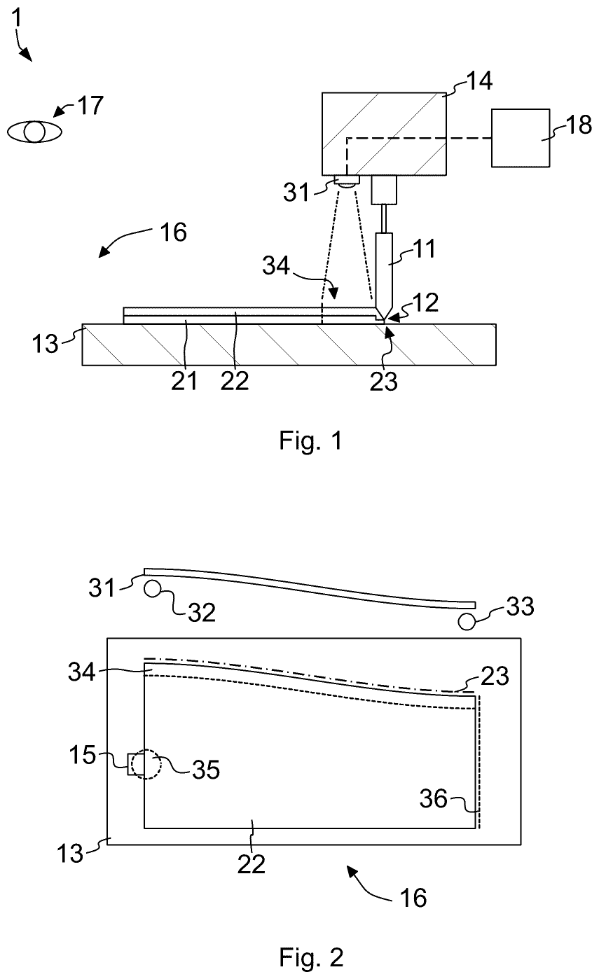

The figures are schematic and by way of example. Identical reference designations in the figures indicate identical functional and/or structural features. The support shown in FIG. 2 can be the support of the fixing device according to FIG. 1.

FIG. 1 shows the fixing device 1 in a lateral sectional view. In this case, a carrier structure 21 is laid flatly on the support 13 of the fixing device 1 and a decorative layer 22 is laid flatly on this carrier structure, wherein a seam blade 11 presses the decorative layer 22 starting from a seam blade bridge 14 using its seam blade edge 12 against the support 13 and thus fixes it along the seam contour 23 for the subsequent laminating process.

In unfavorable illumination conditions, it can occur here that a shadow is generated by the seam blade bridge 14 itself or by other factors in the area 34 of the support 13, or the decorative layer 22 arranged thereon, adjoining the seam blade 11 or adjoining the seam contour 23. The seam contour 23 and the seam blade edge 12 is therefore no longer recognizable or only recognizable with difficulty for an operator 17 or the naked eye of the operator 17 from the working area 16 and the decorative layer 22 and also the carrier structure 21 are only alignable with difficulty in relation to the seam blade edge 12 or along the seam contour 23. This applies in particular if decorative layers 22 made of dark materials are used.

In the variant shown in FIG. 1, a (first) illumination unit 31 is therefore provided on a side of the seam blade bridge 14 facing toward the support 13, which is designed to illuminate the support 13 along the seam contour 23 and in particular in the area 24 directly adjoining the seam contour 23 or the seam blade edge 12 and located between the working area 16 and the seam blade 11, so that the shadow is reduced or eliminated and in particular the course or the alignment of the decorative layer 22 adjoining the weld seam 11 is recognizable.

It is thus significantly easier for the operator 17 to align the decorative layer 22 cleanly, so that after the fixing of the decorative layer 22 on the carrier structure 21 by way of the seam blade 11, laminating can take place and a clean seam can be created along the seam contour 23.

Although the (first) illumination unit 31 can be activated by a control unit 18 only to illuminate the area 34, it is preferably provided that status reports of the fixing device 1 can be output for the operator 17 by way of an actuation of the (first) illumination unit 31 by the control unit 18. In some embodiments, the control unit 18 may comprise a processor and a memory for storing software, instructions, and/or logic to be executed by the processor. Optionally, the control unit 18 may also comprise or be associated with a display or user interface for communication or receipt of data to or from a user.

In this way, not only are additional means for displaying status reports saved, but rather the work is simplified for the operator 17 and the level of safety is enhanced, since the operator 17 does not have to look away from the area 34 essential for the alignment during the manual alignment.

If, for example, a machine parameter of the fixing device 1 relevant for the safety exceeds a limiting value, the (first) illumination unit 31 can be actuated by the control unit 18, for example, in such a way that the illumination unit 31 generates flashing or a flashing light by way of a changing light current. If a multicolored illumination unit 31 is used, the light color can likewise be changed. Thus, for example, the area 34 can be illuminated by a white light and exceeding the limiting value can be indicated by a red light.

Furthermore, sensors can also be provided, which check the positioning of the decorative layer 22. With reference to FIG. 2, for example, a sensor can be provided in the area of the mechanical alignment aid 15 formed as a stop. If the decorative layer 22 detected by the sensor correctly abuts the alignment aid 15, this can be indicated by the (first) illumination unit 31 and, for example, by a green light, so that the operator 17 can register the correct alignment at the alignment aid 15 without looking away from the area 34.

FIG. 2 shows a fixing device 1 in a top view, wherein it can optionally be the fixing device 1 from FIG. 1 in this case. The illustration according to FIG. 2 is simplified and omits the illustration of the seam blade bridge 14 and the seam blade 11 for the sake of clarity. Furthermore, a control unit 18 is also not shown, but is nonetheless present and can be connected at least with respect to control to the first illumination unit 31 and also a second illumination unit 32 and a third illumination unit 33.

It is essential for FIG. 2 that the first illumination unit 31 is formed as a band and corresponds to the seam contour 23, i.e. follows the course of the seam contour 23, due to which the area 34 which is or can be illuminated also corresponds to the seam contour 23.

As mentioned in conjunction with FIG. 1, according to the variant shown in FIG. 2, a mechanical alignment aid 15 is provided, which is specifically formed as a stop on which the decorative layer 22 can come into contact and be aligned.

An unfavorable shadow can also occur in the area of the mechanical alignment aid 15. Although the area 35 adjoining the alignment aid 15 on the decorative layer 22 can also be integrally illuminated by the first illumination unit 31, the variant according to FIG. 2 provides that the second illumination unit 32 is provided for this purpose, which can be arranged, for example, adjacent to the first illumination unit 31 at the seam blade bridge 14.

Furthermore, the third illumination unit 33 can be provided to generate a visual alignment aid 36 by projection on the support 13 and/or on the decorative layer 22.

The disclosure is not restricted in its execution to the preferred exemplary embodiments specified above. Rather, a number of variants are conceivable that make use of the described solution even in fundamentally different types of embodiments.

1. A fixing device for a decorative layer to be laminated on a carrier structure comprising:
a seam blade and a support, on which the carrier structure and the decorative layer are arrangeable such that the decorative layer covers the carrier structure at least in some sections,
wherein the seam blade comprises a seam blade edge to fix the decorative layer and the carrier structure on one another using the seam blade edge along a pre-determined seam contour on the support, and
wherein the fixing device further comprises an illumination unit to illuminate the support along the seam contour.

2. The fixing device according to claim 1, further comprising:
a seam blade bridge, on which the seam blade is held,
wherein the seam blade is movable together with the seam blade bridge and/or starting from the seam blade bridge to fix the decorative layer and the carrier structure against the support,
wherein the illumination unit is arranged at the seam blade bridge.

3. The fixing device according to claim 2,
wherein the seam blade bridge spans the support and is spaced apart therefrom,
wherein the illumination unit is provided on a side of the seam blade bridge facing toward the support.

4. The fixing device according to claim 1,
wherein the illumination unit is formed from a plurality of light sources,
and/or wherein the illumination unit is formed as a band and extends corresponding to the seam contour, so that the seam contour can be illuminated over its entire length.

5. The fixing device according to claim 1, further comprising:
a mechanical alignment aid for aligning the decorative layer and/or the carrier structure on the support,
wherein the illumination unit illuminates an area adjoining the mechanical alignment aid on the support,
and/or a second illumination unit is provided to illuminate the area adjoining the mechanical alignment aid on the support.

6. The fixing device according to claim 1, furthermore comprising:
a working area, on which the decorative layer and/or the carrier structure is alignable manually by an operator on the support,
wherein a longitudinal side of the seam blade faces toward the working area, and
wherein the illumination unit is positioned and/or formed between the working area and the seam blade to illuminate the longitudinal side of the seam blade.

7. The fixing device according to claim 1,
wherein the illumination unit is designed and/or the fixing device comprises a third illumination unit, to project a visual alignment aid on the support.

8. The fixing device according to claim 1, further comprising:
a control unit connected for signaling to the illumination unit, to visually display at least one status report of the fixing device by actuating the illumination unit.

9. The fixing device according to claim 1,
wherein the illumination unit changes a light color and/or a light current of a light generated for the illumination.

10. The fixing device according to claim 1,
wherein a direct line of sight between the illumination unit and the support is free of obstacles generating a shadow on the support.
